(19) United States
(12) Patent Application Publication
(10) Pub. No.: US 2015/0101982 A1
(43) Pub. Date: Apr. 16, 2015

(54) APPARATUS AND METHOD FOR THE EXTRACTION OF HYDROCARBONS AND USE THEREOF IN THE TREATMENT OF OIL CONTAMINATIONS

(71) Applicant: MAN OIL GROUP AG, Zug (CH)

(72) Inventor: Genadi Man, Kussnacht am Rigi (CH)

(73) Assignee: MAN OIL GROUP AG, Zug (CH)

(21) Appl. No.: 14/403,911

(22) PCT Filed: May 28, 2013
(86) PCT No.: PCT/EP2013/060933

§ 371 Date: Nov. 25, 2014

(30) Foreign Application Priority Data
May 29, 2012 (EP) 12169851.8

(51) Int. Cl. C02F 1/26

(52) U.S. Cl. CPC C02F 1/26; C02F 2101/32
USPC 210/634; 210/511; 210/296; 210/294

(57) ABSTRACT

An apparatus for the extraction of liquid hydrocarbons (MHC) has a mechanism for providing a process water composition (PWC) comprising a liquid emulsifier and water, an intake device (10) for collecting a liquid feedstock mixture comprising the hydrocarbons (MHC), a separating system connectable to the intake device, the separating system providing for a processing of the liquid feedstock mixture together with the process water composition so as to extract at least some of the hydrocarbons (MHC) from the liquid feedstock mixture, wherein the liquid emulsifier comprises a natural plant oil, an emulsifier, and preferably also a solubilizer.

The present application relates to an apparatus and method for the extraction of hydrocarbons. Additionally, the present invention relates to the use of an emulsifier or emulsifier concentrate in the treatment of oil contaminations.

The present application claims the priority of the European patent application EP 12169851.8, which was filed on 29 May 2012, which carries the title “Apparatus and method for the extraction of hydrocarbons and use thereof in the treatment of oil contaminations” and which was filed in the name of the present applicant.

The present application is related to the earlier filed, co-pending international patent application PCT/EP2012/056860 (publication number WO 2012140248), with title “Liquid products and method for emulsifying oil, and use thereof in the treatment of oil contaminations”, which was filed on 13 Apr. 2012 and which claims the priority of a European patent application EP11162199.1.

Many research and development experts are concerned with the treatment or elimination of oil contaminations of the surfaces of appliances and machines, which are caused for instance by the industrial processing or handling of hydrocarbons. But also oil contaminations of water, soil, sand and rocks are a major concern. There are a huge number of products and technologies in the market which can for instance be used to initiate a decontamination process.

As far as the existing products are concerned, different routes have been taken. However, until now most products which are efficient and cost-effective are to be classified as toxic materials. Known are products which initiate a chemical oxidation as well as products which in addition to the oxidation achieve a bleaching of the hydrocarbons. This causes the contamination to become less well visible.

More modern products are based on proteins or on highly efficient surfactants (tensides). There are also additives, which increase the efficiency of these products.

There is still some research ongoing regarding products which cause a natural digest or decomposition of the hydrocarbons by means of biodegradation.

A tenside used in the prior art is e.g. PEG-18 castor oil diolelate (e.g. distributed by SASOL OLEFINS & SURFACTANTS GmbH, Paul-Baumann-Str. 1, 45764 Marl, Germany, under the name MARLOWET LVS), which is a non-ionic tenside. Generally, tensides are composed of a polar head and an unpolar chain. The use of PEG-18 castor oil diolelate is of advantage due to its good industrial availability, reasonable pricing and in particular due to its relatively efficiently acting polar head, which mediates a good micelle formation. The polarity is a physical entity or unit which is measured based on the electronegativity difference (called Delta-EN (LEN). Mineral oils typically comprise a mixture of a huge number of different hydrocarbon molecules. A calculation of the polarity is thus impossible.

Good micelle formation is of particular importance, as within the micelles, the hydrocarbon chains present e.g. in mineral oil are dissolved, while the micelles themselves are distributed in the waterous solution via the polar heads of the tenside. Other non-ionic tensides known in the art are e.g. Pentaethylene glycol monododecyl ether, Polyglycerol Polyricinoleate, Lauryl glucoside.

Known in the art is also the use of a plant oil to enhance micelle formation and solving of the hydrocarbons. In particular when using PEG-18 castor oil diolelate as a tenside, the use of castor oil is preferred. As PEG-18 castor oil diolelate is based on castor oil, both are known suitable components resulting in a stable mixture, in particular for dissolving hydrocarbons with smaller chains up to C₁₂.

Also known in the art is the use of a solubilizer for diluting the micelles and to act as co-tenside. Commonly alcohols, in particular ethanol and isopropanol are used as solubilizer, but also the use of e.g. glycol ether is known.

However, known tenside compositions of the prior art have several disadvantages. A major drawback is the requirement to adopt a composition to the specific type of oil which has to be emulsified. For instance, depending on the region of origin, mineral oils comprise a specific and individual composition of various types of hydrocarbons. Accordingly, the type of oil contamination e.g. of a soil, sand, machine or ocean slug has to be analysed with respect to a suitable tenside composition, and the effective tenside or tenside mix for a specific oil contamination is to be tailored in a series of experiments. This, however, is cumbersome and consequently time- and cost-intensive, and the resulting tenside composition might provide only a very limited effectiveness with respect to other oil contaminations. Furthermore, the preparation of numerous individual tenside compositions raises problems in effective stocking. Thus, the lack of “universality” generally impairs handling properties of prior art tenside compositions.

Another disadvantage of prior art tenside compositions is the difficult recovery of tenside/oil emulsions, but there are procedures which enable the hydrocarbons to be recovered.

In the above fields so-called green technologies receive a lot of attention.

In this context the applicant has developed more modern and more efficient liquid emulsifier products with a larger range of applications. The new liquid emulsifier products, as disclosed in the above-mentioned international patent application, offer a high environmental compatibility combined with an efficient and economic application.

There is a need for an apparatus which facilitates the automated or semi-automated handling of contaminated water, soil, sand, rocks and other objects or materials. The respective apparatus should provide for an efficient and reliable extraction of hydrocarbons. The apparatus and method should be designed so as to allow the redemption or recovery of at least some of the liquid emulsifier products.

According to the invention an apparatus and method are provided for the extraction of hydrocarbons and for cleaning a broad spectrum of oil-contaminated media and objects such as water, soil, slugs, sands, stones, rocks, machines, or sea regions.

The respective apparatus and method provide for an improved recovery of liquid hydrocarbons, preferably in the form of oil.

According to the invention an apparatus for the extraction of liquid hydrocarbons is provided. This apparatus includes means for providing a process water composition as working solution which comprises a liquid emulsifier product and water. The apparatus further comprises an intake device for collecting a liquid (recoverable) feedstock mixture comprising the hydrocarbons to be extracted. The liquid feedstock mixture also comprises water and in some cases also solid inclusions. The apparatus further comprises a separating system connectable to the intake device to provide for a processing of the liquid feedstock mixture together with the process water composition so as to extract at least some of the hydrocarbons from the liquid feedstock mixture. The liquid emulsifier comprises

(a.) a natural plant oil, and

(b.) an emulsifier.

The emulsifier preferably comprises a non-ionic tenside and/or an anionic tenside.

In a first embodiment an emulsifier concentrate is provided which is used to produce the liquid emulsifier. The emulsifier concentrate preferably comprises a natural plant oil, an emulsifier which comprises a non-ionic tenside and an anionic tenside, and an optional solubilizer (e.g. an alcohol). This emulsifier concentrate preferably comprises 30-50 Vol % of a natural plant oil (e.g. selected from colza oil, corn oil, sunflower oil); 10-25 Vol % of an alcohol as a solubilizer (e.g. octanol), and 27-55 Vol % of an emulsifier, consisting of 25-45 Vol % of a non-ionic tenside, and 0.5-10 Vol % of an anionic tenside.

In a second embodiment another emulsifier concentrate is provided which is used to produce the liquid emulsifier. This emulsifier concentrate preferably comprises a natural plant oil, and a non-ionic tenside (e.g. secondary alkyl sulfate) serving as emulsifier. In a second embodiment the emulsifier concentrate or the liquid emulsifier might comprise an alcohol as solubilizer which is not impacting bioremediation (e.g. an alcohol with high acidity). There are applications, however, where no alcohol is required.

In all embodiments of the invention the liquid emulsifier is employed in order to launch a separation of the liquid hydrocarbons from water and other possible inclusions.

All embodiments of the invention are based on an efficient combination of chemical and physical mechanisms. The liquid emulsifier is mainly employed in order to launch or improve the emulsification of the liquid feedstock mixture. The liquid emulsifier interacts with the liquid hydrocarbons and enables or facilitates the formation of phases that can be separated using physical mechanisms. The liquid emulsifier forms with the liquid hydrocarbons a dispersed phase in the water phase of the liquid feedstock mixture.

The liquid emulsifier might even provide for a breakdown of long chain hydrocarbons into smaller, uniformly distributed hydrocarbons.

Preferably the emulsifier concentrate is diluted in water in a dilution ratio of 1 part of the concentrate and 70 to 130 parts water. The respective solution or mixture is herein referred to as process water composition.

According to the invention the process water composition is applied to the liquid hydrocarbons (e.g. in the form of oil) inside the apparatus.

The emulsifier concentrate and the process water composition comprising the emulsifier concentrate in diluted form is/are based on a new combination of specific, single components, which are provided in specific, particularly effective concentration ranges. When provided as a concentrate, the emulsifier composition may be easily stored, and also the handling for transportation is simplified because the concentrate has a high flash point. Furthermore, the emulsifier concentrate, when diluted with water to specific process water compositions, provides a surprisingly high efficiency in the apparatus-based treatment of oil contaminations, including:
a faster and better solving of liquid hydrocarbons (e.g. oil contaminations),
an improved extraction of liquid hydrocarbons (or recovery of the oil from an oil contamination),
a larger spectrum of hydrocarbons which may be solved, simply by choosing an appropriate dilution ratio when preparing the process water composition, and
a reduced toxicity for oil-degrading microorganisms, thereby improving the quality of the treated oil contaminations for a subsequent bioremediation.
The emulsifier concentrate and the process water composition based thereon have excellent properties for use in an apparatus for the extraction of hydrocarbons since neither the emulsifier concentrate nor the process water composition are flammable, toxic, or chemically aggressive.

It is a further advantage of the inventive emulsifier and process water compositions that the respective oil-emulsifier emulsion has a very low density which causes the emulsion with the liquid hydrocarbons to float at or near the water surface. This behaviour is advantageous since the emulsion is easily accessible and can thus be treated or separated more easily in an automated or semi-automated fashion inside the apparatus.

Please note that the tensides mentioned herein are also called surfactants. The word tenside can herein be replaced by the word surfactant.

In a third aspect, also the particular use of the specific formulations of the specific emulsifier concentrates according to the present invention account to the particular advantages of said emulsifier concentrate. The inventors have surprisingly found that the specific formulations in the emulsifier concentrate, results in improved emulsion properties of liquid hydrocarbons when at the same time also mechanical processes for the processing of the liquid feedstock mixture.

The given volume percentages for the single components of the emulsifier concentrate according to the present invention essentially refer to a total volume of emulsifier concentrate of 100%.

The emulsifier concentrates and process water compositions are particularly well suited for the application on a broad range of oil contaminations. Furthermore, as the concentrate has a flash point above 80° C. and a shelf life of at least 2 years after production of the emulsifier concentrate, also transportation and storage is simplified. The emulsifier concentrate is not toxic, it is biologically degradable, and it has a relative density in a range between 0.8 and 1.

When being applied to the object (e.g. sand) or medium (e.g. water) which is contaminated with liquid hydrocarbons (e.g. in the form of oil) in an apparatus according to the invention, the emulsifier concentrate is diluted with water to produce the process water composition. Preferred process water compositions comprise a liquid emulsifier prepared from dilutions in a dilution ratio of 1 part of the concentrate and 70 to 130 parts water.

Advantages of the process water composition according to the present invention includes a rapid solving of contaminating liquid hydrocarbons (e.g. oil) in the emulsion solution. Additionally, the recovery of oil is simplified, as after solving the oil to a saturated emulsion, the oil accumulates on the surface of the liquid composition.

The process water composition, produced from respective dilutions of the emulsifier concentrate with (plant) water, may additionally comprise further additives. Such additives are known in the art and should therefore not be mentioned in detail at this place. Only exemplarily mentioned, such additives include dyestuffs (e.g. a fluorescent substance), UV-stabilizers, identification markers for uniquely identifying the manufacturer of the emulsifier concentrate, and so forth.

In a preferred embodiment the apparatus comprises at least two stages which enable a stage-by-stage separation of liquid hydrocarbons from water and, if present, from solid inclusions. The respective set-up is herein also referred to as cascaded set-up.

In a preferred embodiment the apparatus comprises

means for recirculation of the process water composition and/or

means for recirculation of the liquid emulsifier and/or

means for preheating of the process water composition and/or

means for extracting heat from hydrocarbons.

In a preferred embodiment the apparatus is a complex or plant with at least one stage for the extraction of a liquid feedstock mixture from an oil sludge storage facility or from another source and at least one stage for processing this feedstock by dividing liquid hydrocarbons and water. The apparatus enables to carry out operations in an automated or semi-automated mode with a feedstock capacity of several cubic meters per hour.

The apparatus comprises at least one stage (in a preferred embodiment up to ten stages) to perform works in field conditions in oil sludge storage areas or in areas of oil spills.

In addition, the apparatus can use industrial sources of electricity and steam (if locally available).

The apparatus comprises at least a feedstock extraction system (consisting of or comprising an intake device) and one or more of the following stages/systems:
A pulp preparation system
A large-scale purification system
A system to separate pulp into liquid and solid phases
A liquid phase separation system
A solid phase discharge system
A system to prepare process water composition
A system for circulation of process water composition PWC
An automatic control system with an optional ability of remote control from an operator console and on-site (operator's room).
A heating system as part of the process water composition circulation system (hot water might be taken from a self-contained water boiler, a heat exchanger or from an enterprise's centralized steam preparation system as heat medium through a steam-water heat exchanger)
A hydrocarbons storage unit.

The present invention also includes a method of extracting liquid hydrocarbons, in particular contaminations of, for example, mineral oils. The method according to the present invention comprises the steps of
providing a liquid emulsifier according to one of the embodiments described above,
producing a process water composition comprising one part of the emulsifier with 70-130 parts of water,
applying the process water composition to a liquid feedstock mixture or watery feedstock mixture which comprises liquid hydrocarbons (e.g. in the form of oil) in order to launch the formation of an emulsion by means of a chemical interaction of the emulsifier with liquid hydrocarbons,
carrying out a physical (mechanical) process in order to extract at least some of the liquid hydrocarbons from said emulsion, said physical (mechanical) process delivering at least some of the process water composition,
re-using the process water composition delivered by the physical (mechanical) process.

The emulsifier concentrate and the process water composition, which together serve as working solution, are particularly useful for the treatment of oil in soils or oil slugs on ocean surfaces and of other accumulations of oil.

The liquid feedstock mixture, that is the liquid to be cleaned or processed, is in preferred embodiments either provided in a natural or artificial pond or basin, or it is provided or contained in a tank or container.

Important is the surface enlargement (increasing the contact surface) by means of agitation and/or stirring and/or creating a stream or flow for collecting the liquid feedstock mixture. This improves the effectiveness of the liquid emulsifier and the separation of the liquid hydrocarbons from water and other possible inclusions. All embodiments of the invention are based on such an efficient combination of physical mechanisms and chemical interactions/reactions.

### BRIEF DESCRIPTION OF THE DRAWINGS

Further characteristics and advantages of the invention will in the following be described in detail by means of the description and by making reference to the drawings. The drawings show simplified hydrokinematic diagrams.

FIG. 1 shows a schematic diagram of a first embodiment of the invention;

FIG. 2 shows a schematic diagram of a portion of a second embodiment of the invention;

FIG. 3 shows a schematic diagram of a portion of a third embodiment of the invention;

FIG. 4 shows a schematic diagram of a portion of another embodiment of the invention;

FIG. 5 shows a schematic diagram of a portion of another embodiment of the invention;

FIG. 6 shows a schematic diagram of a portion of another embodiment of the invention;

FIG. 7 shows a schematic diagram of a portion of another embodiment of the invention;

FIG. 8 shows a schematic diagram of a portion of another embodiment of the invention;

FIG. 9 shows a schematic diagram of a portion of another embodiment of the invention;

FIG. 10 shows a schematic diagram of a portion of another embodiment of the invention;

FIG. 11 shows a schematic diagram of a portion of another embodiment of the invention;

FIG. 12 shows a schematic diagram of a portion of another embodiment of the invention.

It shall be noted that the figures are not drawn to scale and that certain details have been drawn out of scale for clarity.

### DESCRIPTION OF THE PREFERRED EMBODIMENTS

Certain terms are used herein, the formulation of which should not be interpreted to be limited by the specific term chosen, but as to relate to the general concept behind the specific term. Some of the abbreviations which are used are listed and explained in the attached reference number listing. Some of the more important terms and expressions are hereinafter defined.

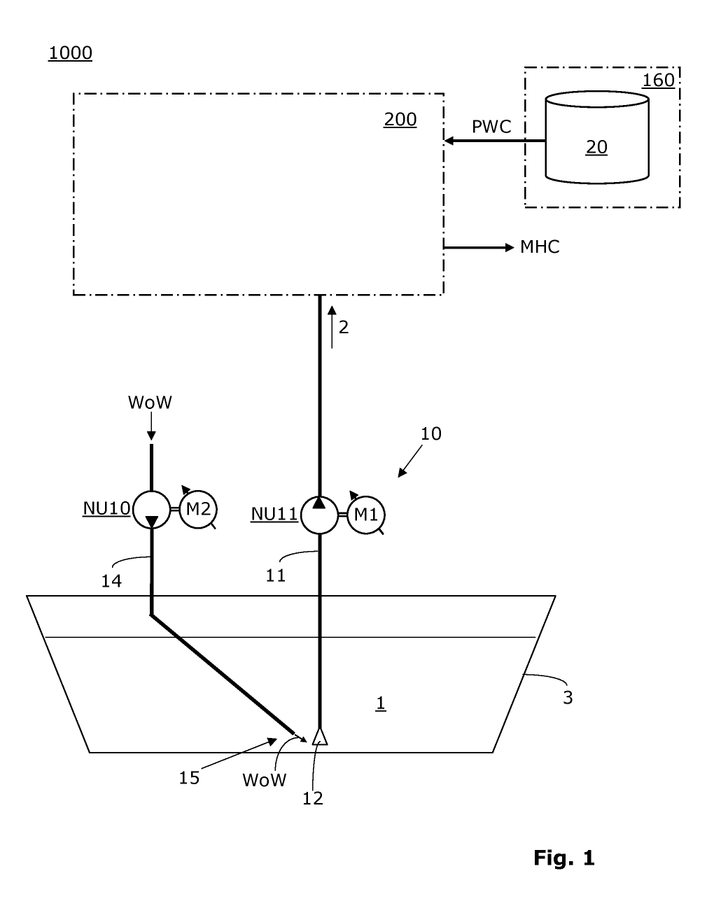

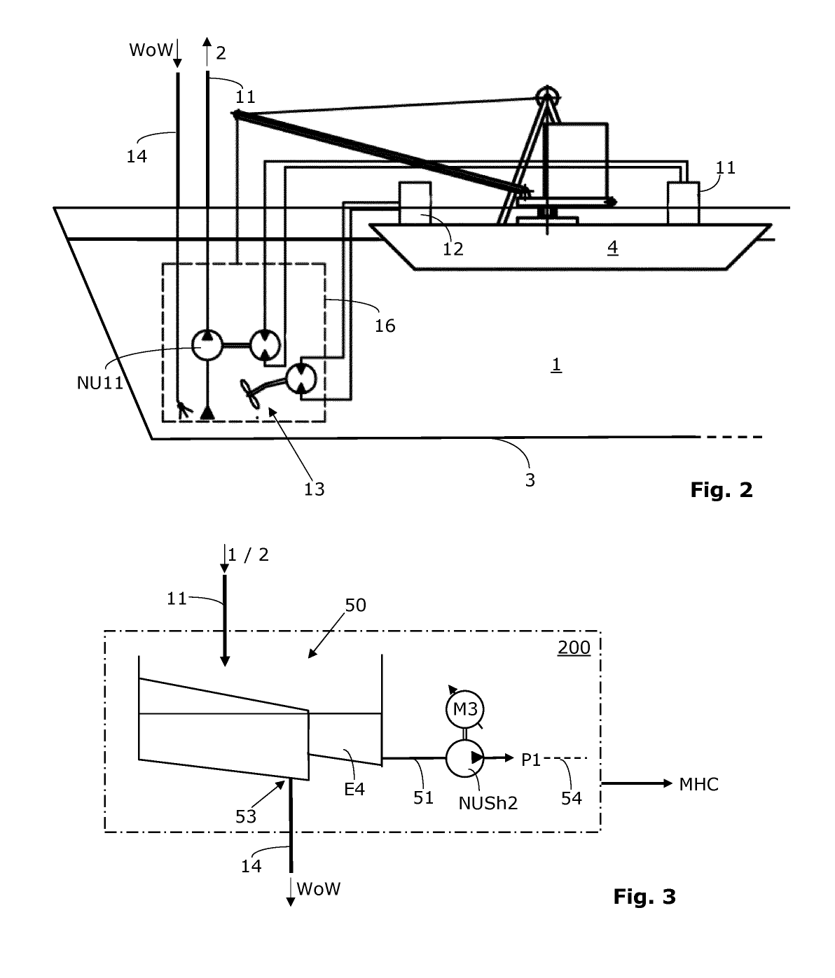

An oil sludge storage facility (OSSF) 3 is a specially equipped location for oil sludge storage. A sludge tank, container, barn, landfill, sludge depositary and other means are suitable as oil sludge storage facility 3. Typically, the liquid feedstock mixture 1, which comprises the liquid hydrocarbons (typically a mixture of liquid hydrocarbons: MHC) and water, is put into an oil sludge storage facility 3. Examples of oil sludge storage facilities 3 are shown in FIGS. 1 and 2.

Typically, the liquid feedstock mixture 1 comprises one or more of the following components or elements:

paraffin hydrocarbons (e.g. petroleum);

asphaltenes;

inert sand and mud;

stones, rocks, sea shells;

mineral deposits;

(sea) water.

The liquid feedstock mixture 1 has an oily viscous mass with semi-solid or solid materials. The liquid feedstock mixture 1 might have a ratio of the solid fractions and the liquid hydrocarbons and water of approximately 60-15-25%, respectively.

The apparatus 1000 enables the processing of a liquid feedstock mixture 1 having a viscosity of up to 100,000 cSt (centiStokes).

The liquid feedstock mixture 1 might be stored in an oil sludge storage facility 3, as mentioned. The liquid feedstock mixture 1 could also be directly taken, gathered or soaked up from a lake, pond or from an ocean area which is contaminated. If the liquid feedstock mixture 1 is directly taken from a lake, pond or from an ocean area, the ratio of the solid fractions and the liquid hydrocarbons and water might for instance be approximately 5-15-80%, respectively.

It there is too much water in the liquid feedstock mixture 1, the respective liquid feedstock mixture 1 might be put into an oil sludge storage facility 3 where it settles down. If one lowers an intake device 10 into the right zones of such an oil sludge storage facility 3, a liquid feedstock mixture 1 can be extracted which contains more liquid hydrocarbons and less water.

All embodiments of the invention comprise an intake device 10. The intake device 10 is designed and employed for collecting the liquid feedstock mixture 1 comprising liquid hydrocarbons MHC. As illustrated in FIGS. 1 and 2, the intake device 10 might comprise a hose or pipe 11 which conveys or guides the feedstock 1 from a source (e.g. the oil sludge storage facility 3 or a lake, pond or ocean area) to a separating system 200 of the apparatus 1000.

For the purposes of the present invention
a liquid oil sludge is an oil sludge containing low solid phase in not more than 20% (volume), and
a solid oil sludge is an oil sludge containing solid phase in 20% (volume) to 60% (volume).
Plant water (PW) is water other than drinking, mineral and industrial water suitable for use in national economy.
A liquid emulsifier (NHS) is a liquid product intended to launch and/or intensify the processes of separating a mixture of liquid hydrocarbons MHC from (sea) water and from possible solid inclusions (SI).
A process water composition (PWC) is a composition of plant water and liquid emulsifier NHS in a specified concentration. The process water composition PWC is preferably (pre-)heated in order to improve the physical (mechanical) process of extraction of hydrocarbons.
Pulp (P1, P2, P3, P4, pLF) is a diluted composition of feedstock with water or with a process water composition. Depending on the actual embodiment of the invention, different types or “qualities” of pulp are provided and processed inside the apparatus 1000. The more stages or systems the apparatus 1000 comprises, the cleaner the pulp gets in the upstream process direction.
A cake has a solid phase (mineralized components or solid inclusions of the feedstock 1 after separation of the main volume of a mixture of liquid hydrocarbons and water). Cake is extracted from pulp P1, P2, P3, P4, pLF.
A homogenization process provides for an equilibrium distribution of the solid phase SF in the liquid phase of pulp P1, P2, P3, P4, pLF.

For the purposes of the present invention a chemical mechanism is a chemical interaction such as an ion-dipole, dipole-dipole, dipole-induced dipole, induced dipole-induced dipole interaction. A chemical interaction is not a chemical reaction in the classical sense. The formation of an emulsion is a phenomenon which is based on chemical interactions. The Van der Waals force, for instance, causes chemical interactions.

For the purposes of the present invention one or more of the following physical (mechanical) mechanisms are employed by the apparatus 1000 in order to improve the extraction efficiency:

surface enlargement (increasing the contact surface) and/or

homogenization (e.g. carried out by a hydrojet treatment system 80) and/or

agitation (e.g. by stirring in a stirrer 70) and/or

settling (e.g. in a preliminary separation tank 50) and/or

cyclone fields (e.g. in a hydrocyclone 93.1) and/or

centrifugation and/or

heating.

The apparatus 1000 in all embodiments is a closed technological line to extract the liquid hydrocarbons, preferably in the form of oil sludge, from a storage facility, such as an oil sludge storage facility 3, or from a lake, pond or ocean area.

In a preferred embodiment, the apparatus 1000 comprises in addition to the feedstock extraction system (consisting of or comprising the intake device 10) one or more of the following stages/systems:
A pulp preparation system
A large-scale purification system
A system 90 to separate pulp into liquid and solid phases
A liquid phase separation system 110
A solid phase discharge system 120
A system 160 to prepare process water composition
A system 130 for circulation of process water composition PWC
An automatic control system (ACS) with an optional ability of remote control from an operator console and on-site (operator's room).
A heating system (hot water might be taken from a self-contained water boiler, a heat exchanger or from an enterprise's centralized steam preparation system as heat medium through a steam-water heat exchanger)
A hydrocarbons storage system 150.

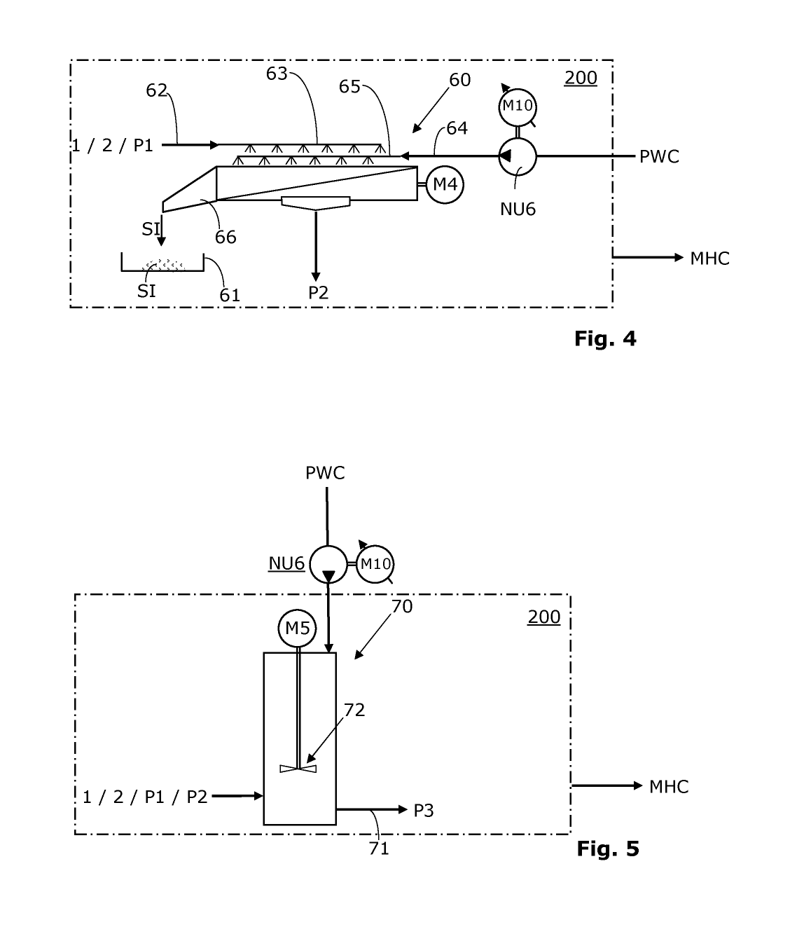

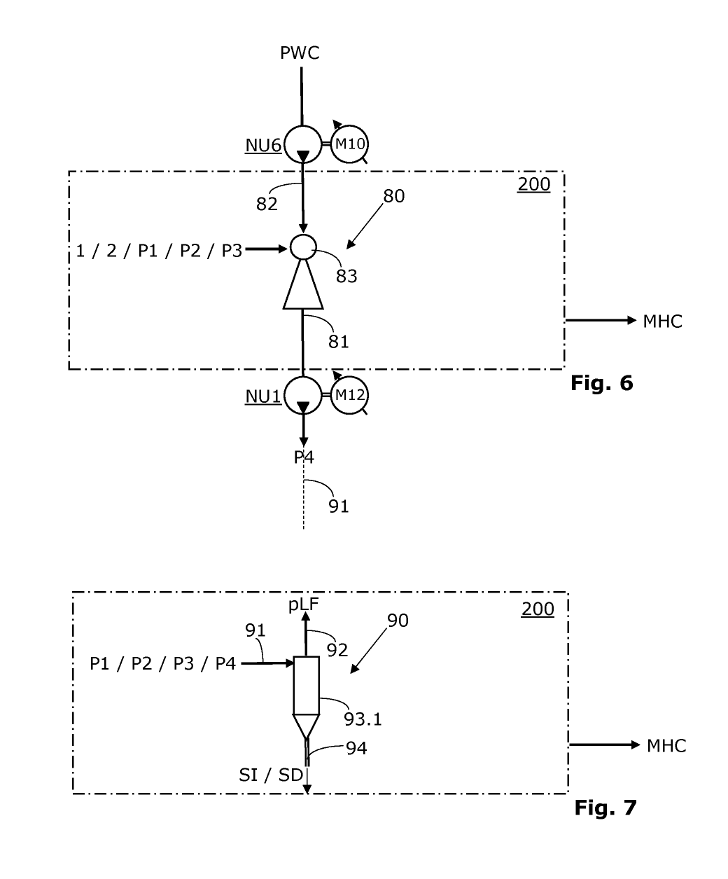

These stages/systems are designed for
a pre-treatment and preparation of pulp (a preliminary separation tank 50, as illustrated in FIG. 3 might be employed for this purpose),
a pre-separation of large foreign solid inclusions ID (a tumbler 60, as illustrated in FIG. 4, might be employed for this purpose),
a subsequent separation of the prepared pulp P2 into liquid and solid phases LF, SF (a stirrer 70, as illustrated in FIG. 5, and/or a hydrojet treatment system 80, as illustrated in FIG. 6, and/or a system designed to separate pulp into liquid and solid phases LF, SF, as illustrated in FIG. 7, might be employed for this purpose),
a deep division of the liquid phase LF into a mixture of liquid hydrocarbons and water,
a removal of separation products from the apparatus 1000.

### Feedstock Extraction System:

It is the purpose of the feedstock extraction system to collect a liquid feedstock mixture 1 and to supply it to a subsequent stage/system (e.g. the pulp preparation system). The feedstock extraction system comprises at least the intake device 10 with a hose or pipe 11 for conveying or guiding the liquid feedstock mixture 1 from a source (e.g. the oil sludge storage facility 3 or a lake, pond or ocean area) to a subsequent stage/system.

In a preferred embodiment, the feedstock extraction system comprises means for washing-out oil sludge or solid inclusions SI with water, as illustrated in FIGS. 1 and 2. In both figures, embodiments are shown where pressurized washing-out water WoW is employed to improve the collection of the liquid feedstock mixture 1. The respective means might comprise a pump (e.g. the pump NU10 together with an associated motor M2) and the hose or pipe 14, to produce a water stream at an outlet end or nozzle 15 of the hose or pipe 14. These means help to create a stream or flow which eases the collection of the liquid feedstock mixture 1 by the intake device 10. If washing-out water WoW is employed, as described, the liquid feedstock mixture 1 typically comprises more water than in cases where no washing-out water WoW is employed. The respective mixture is thus herein referred to as watery feedstock mixture 2.

In a preferred embodiment, the apparatus 1000 comprises a heating system for heating the washing-out water WoW. An intake device 10 emitting pre-heated washing-out water WoW enables the extraction of liquid feedstock mixtures 1 of any composition. The washing-out water WoW might be pre-heated to up to 95° C.

Washing-out water WoW is preferably employed if solid oil sludge components or elements or high viscosity oils are to be extracted. If the liquid feedstock mixture 1 comprises mainly low viscosity liquid hydrocarbons MHC, no washing-out water WoW might be required.

In a preferred embodiment, the apparatus 1000 comprises a feedstock extraction system with the following components: roof, float or vessel 4 (see FIG. 2) floating on the liquid feedstock mixture 1, an immerged sludge intake device 10 with a (boost) pump NU11 and an optional agitator 13. The agitator 13 and/or the pump NU11 might be powered/driven from aboard. For this reason, the roof, float or vessel 4 might be equipped with one or two (hydraulic) compressors 11, 12. A first compressor 11 powers the pump NU11 and a second compressor 12 powers the agitator 13 via corresponding pressure lines.

The agitator 13 and/or the pump NU11 might also be powered/driven from some other place (e.g. using electric motors).

In a preferred embodiment, the apparatus 1000 comprises a dome or container 16 which is at least partially closed. The dome or container 16 is employed in order to provide a controlled environment close to the point where the liquid feedstock mixture 1 or watery feedstock mixture 2 is collected by the intake device 10. The dome or container 16 is optional.

### Pulp Preparation System:

It is the main purpose of the pulp preparation system to receive and process the intake. The pulp preparation system is part of the separating system 200.

The separating system 200 is illustrated in the Figures by dash-dotted boxes.

The pulp preparation system prepares a preliminarily washed out feedstock mixture (herein referred to as first pulp P1) from the liquid feedstock mixture 1 or from the watery feedstock mixture 2. The pulp P1 might comprise a cake content of up to 45-60%. The pulp preparation system preferably in all embodiments comprises a (preliminary) separation tank 50, as illustrated in FIG. 3. The preliminary separation tank 50 is connectable to the intake device 10 by means of a hose or pipe 11. The preliminary separation tank 50 is designed to provide for an extraction of the first pulp P1 either from the liquid feedstock mixture 1 or from the watery feedstock mixture 2. The preliminary separation tank 50 has an outlet 51 for providing the first pulp P1. It typically also comprises a water outlet 53 for releasing water. The water provided at this water outlet 53 can be used as washing-out water WoW. In this case the corresponding outlet 53 is connected to the hoe or pipe 14, as indicated in FIG. 3.

If the water at the water outlet 53 is not required, it might be transferred back to the sludge depository 3 or into a lake, pond, river or ocean.

In a preferred embodiment, a tank E4 is attached to the preliminary separation tank 50. In the tank E4 the washing-out water WoW is preliminarily separated from the pulp P1.

In a preferred embodiment, a pump NU10 is employed to supply the washing-out water, as illustrated in FIG. 1.

In a preferred embodiment, a sludge pump NUSh2 is employed to feed the first pulp P1 from the tank E4 to a subsequent stage/system. The sludge pump NUSh2 can be driven by a motor M3. The first pulp P1 is transferred from the tank E4 by the pump NUSh2 preferably via a pulp feed-line 54 into the tumbler 60 and/or stirrer 70 and/or hydrojet treatment system 80 of the large-scale purification system.

In a preferred embodiment in order to maintain circulating water balance, the process water composition PWC, preferably heated up to 95° C., is delivered (if necessary) to the tank E4 from the system 130 for circulation of process water composition PWC.

### Large-Scale Purification System:

It is the purpose of the large-scale purification system to purify the pulp P1 (if the first pulp P1 is fed from the preliminary separation tank 50 to the large-scale purification system) or the liquid feedstock mixture 1 (if the liquid feedstock mixture 1 is fed right to the large-scale purification system) or the watery feedstock mixture 2 (if the watery feedstock mixture 2 is fed right to the large-scale purification system) from solid particles (called solid inclusions SI) having a size of more than 2 mm, for example.

In a preferred embodiment, the large-scale purification system comprises a tumbler 60, as illustrated in FIG. 4. Preferably, a tumbler screening machine is used in all embodiments as tumbler 60. The tumbler 60 enables the mixing of the first pulp P1, or the liquid feedstock mixture 1, or the watery feedstock mixture 2 with the process water composition PWC (preferably, the PWC process water composition is preheated up to 95° C.). The first pulp P1, liquid feedstock mixture 1, or watery feedstock mixture 2 is fed via an inlet 62 into the tumbler 60. The inlet 62 might comprise a nozzle or nozzle array 63 for releasing the first pulp P1, liquid feedstock mixture 1, or watery feedstock mixture 2 into the tumbler 60. The tumbler 60 receives the process water composition PWC via an inlet 64. The inlet 64 might comprise a nozzle or nozzle array 65 for releasing the process water composition PWC. The tumbler 60 might be put into rotation by a motor M4, as illustrated in FIG. 4.

In a preferred embodiment, the tumbler 60 further comprises a hopper 61 being arranged so that the tumbler 60 is able to discharge the solid inclusions SI into the hopper 61. As illustrated in FIG. 4, the tumbler 60 might comprise a gravity chute 66 for discharging the solid inclusions SI.

The tumbler 60 is primarily designed to carry out a screening process so as to separate the solid inclusions SI.

The tumbler 60 is preferably designed to separate solid inclusions SI having size of more than 2 mm from pulp, and preferably the pulp is heated by its mixing with preheated PWC or by a separate heating system. The tumbler 60 might be equipped with an optional device to disintegrate cake inclusions.

In a preferred embodiment, the large-scale purification system comprises a stirrer 70 instead of the tumbler 60 or in addition to the tumbler 60. Details of a suitable stirrer 70 are presented in FIG. 5. Preferably, a hot-plate stirrer is employed as stirrer 70. The stirrer 70 is designed to provide for a dilution of the liquid feedstock mixture 1, or of the watery feedstock mixture 2, or of pulp P1 or P2 provided by a downstream stage or system 50, 60. The stirrer 70 provides for a homogenization and it has an outlet 71 for releasing a diluted pulp P3. It is advantageous to employ a stirrer 70 which can heat the pulp. The heating function is optional. Inside the stirrer 70 there is an agitator 72. The agitator 72 is preferably driven by a motor M5. In a preferred embodiment an open-type turbine stirrer is used as agitator 72.

In all embodiments which comprise a stirrer 70, the stirrer 70 creates a homogenized slurry (herein referred to as diluted pulp P3). The stirrer 70 contributes to an intense separation of liquid hydrocarbons (oil products OP) from solid inclusions SI by increasing the contact surface of the solid phase SF with the liquid emulsifier NHS contained in the (preheated) process water composition PWC.

In a preferred embodiment, the large-scale purification system comprises a stirrer 70 in fluid connection with the tumbler 60. After pulp washing-out on the tumbler 60 the prepared pulp P2 is transferred for heating and making a homogenized mixture (diluted pulp P3) to the stirrer 70.

In a preferred embodiment, a hydrojet treatment system 80 is connected to the stirrer 70 and/or tumbler 60 for intensive mixing of the pulp P2 and/or P3. Likewise, a hydrojet treatment system 80 could also be connected to the separation tank 50 in order to process the first pulp P1.

In a preferred embodiment, the large-scale purification system comprises a hydrojet treatment system 80 instead of the stirrer 70 and instead of the tumbler 60 or in addition to the tumbler 60 and stirrer 70. The hydrojet treatment system 80 can be connected to the intake device 10 for processing the liquid feedstock mixture 1 or it can be fed with a watery feedstock mixture 2. Likewise, the hydrojet treatment system 80 can be fed by pulp P1, P2, P3. The hydrojet treatment system 80 provides for a mixing of components or elements of the liquid feedstock mixture 1, or watery feedstock mixture 2, or pulp P1, P2, P3. It has an outlet 81 for releasing mixed (homogenized) pulp P4.

When mixed in the hydrojet treatment system 80, part of the (preheated) circulating process water composition PWC is transferred as operating fluid to a PWC inlet 82 of the nozzle 83 of the hydrojet treatment system 80.

Best results are achieved if a tumbler 60 is followed by an upstream stirrer 70 which in turn is followed by an upstream hydrojet treatment system 80. The tumbler 60, stirrer 70 and hydrojet treatment system 80 are arranged in a cascaded fashion. The mixed pulp P4 at the outlet 81 (preferably heated up to a temperature of 60° C. to 80° C.) is transferred to the inlet of a pump NU1, as indicated in FIG. 6. The pump NU1 might comprise an associated motor M12.

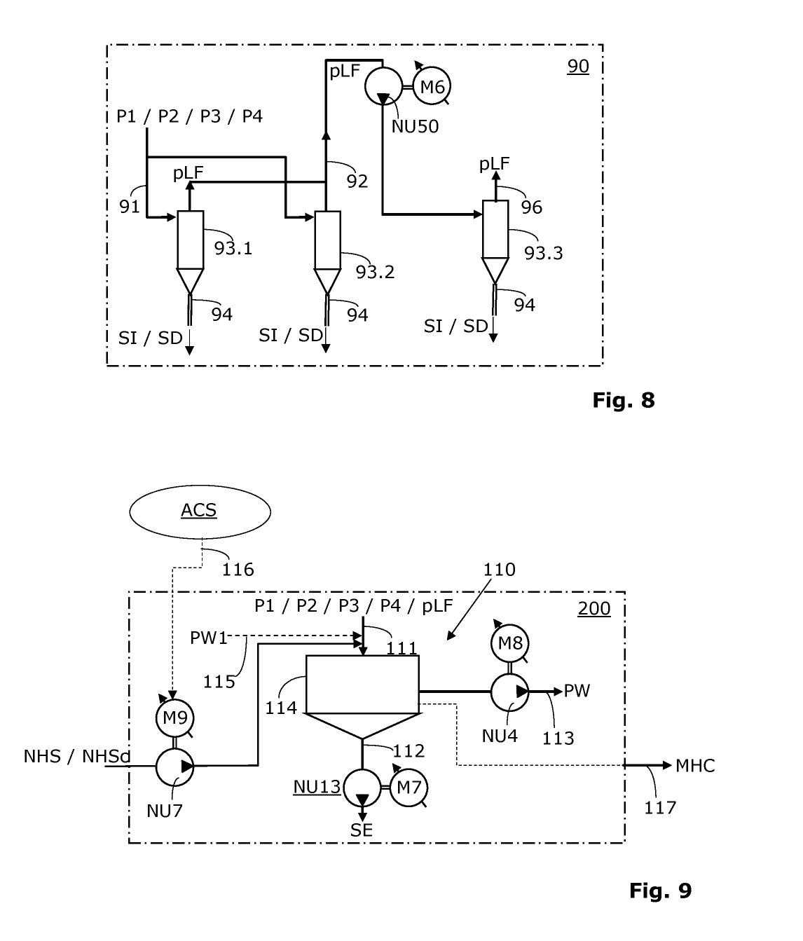

In a preferred embodiment, the pump NU1 feeds the mixed pulp P4 via a hose or pipe connection to the input 91 of a subsequent first hydrocyclone 93.1, as illustrated in FIG. 7, or to a parallel arrangement of two hydrocyclones 93.1, 93.2, as illustrated in FIG. 8. The supply and head pressure of the pump NU1 is regulated (maintaining the pressure at the inlets 91 of the hydrocyclone(s) 93.1, 93.2, 93.3) by changing the rotation frequency of the electric motor M12 of the pump NU1.

In all embodiments of the invention, the pumps might be driven by associated electric motors. Likewise, in all embodiments the pumps can be driven by hydraulic pressure.

In all embodiments the large-scale purification system provides for a dilution of pulp and it homogenizes the pulp.

System to Separate Pulp into Liquid and Solid Phases 90:

It is the main purpose of this system 90 to separate solid particle inclusions SI from the pulp P1, P2, P3, P4. The system 90 is designed to separate the pulp P1, P2, P3, P4 into liquid and solid phases in the form of a purified liquid phase pLF and solid division products SD. The system 90 comprises at least one hydrocyclone 93.1 which is designed in order to separate solid particles from the pulp P1, P2, P3, P4 received via an inlet 91. The hydrocyclone/s 93.1 has an outlet 92 (called exhaust hole or port) for releasing the purified liquid phase pLF, as illustrated in FIG. 7 or 8.

The hydrocyclone/s 93.1 is/are designed to establish a centrifugal force field for the processing of the pulp P1, P2, P3, P4 in order to separate out solid division products SD.

Preferably, the hydrocyclone/s 93.1 has/have a port 94 (called sand hole) for releasing the solid division products SD, as illustrated in FIG. 7 or 8.

In a preferred embodiment two or three cylinder-conic hydrocyclones 93.1, 93.2, 93.3 are employed. It is advantageous if two hydrocyclones 93.1, 93.2 are operated in parallel.

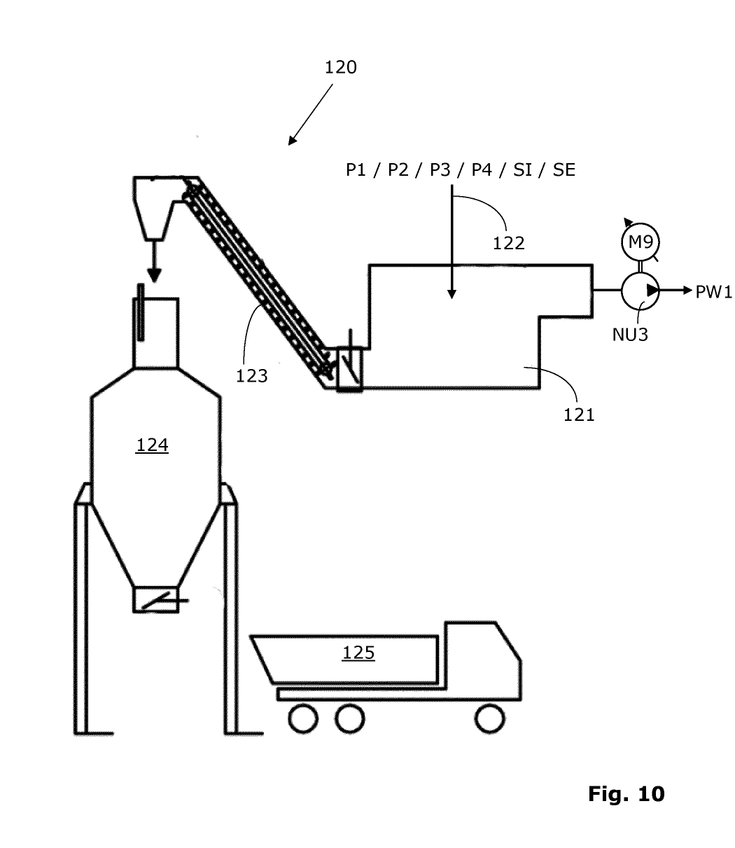

Caked division products might be disposed through the sand holes or ports 94 of the hydrocyclones 93.1, 93.2, 93.3. The liquid phase (exhaust of the hydrocyclones 93.1, 93.2, 93.3) is disposed through the exhaust holes 92 and preferably mixed with water supplied by a water pump NU3 from a hopper 121 (see FIG. 10). The purified liquid phase pLF might be delivered into the liquid phase separation system 110 while the caked product (solid division products SD) is delivered into an optional tank or hopper of an optional solid phase discharge system 120.

The caked product (solid division products SD) might be transferred from the optional tank or hopper for final purification by a pump NU50 directly or indirectly via an inlet 95 to a third hydrocyclone 93.3. Clarified liquid is transferred from the third hydrocyclone 93.3 to the liquid phase separation system 110, and caked liquid is preferably delivered from the third hydrocyclone 93.3 into the solid phase discharge system 120.

### Liquid Phase Separation System 110:

It is the main purpose of the liquid phase separation system 110 to separate (plant) water PW and liquid hydrocarbons (oil products OP), as illustrated in FIG. 9. The liquid phase separation system 110 might be designed to supply water PW, which was purified from oil products OP, to another system (e.g. to the system 160 to prepare process water composition). The liquid phase separation system 110 might contain means for the disposal of extracted oil products OP into a optional hydrocarbons storage system 150.

In a preferred embodiment, the liquid phase separation system 110 comprises a gravity dynamic separator 114 with an outlet 112 providing the liquid hydrocarbons MHC (oil products OP) and an outlet 113 providing the water PW. The gravity dynamic separator 114 has an inlet 111 via which it is supplied with pulp P1, P2, P3, P4, or, in preferred embodiments, with the purified liquid phase pLF received from one or more of the hydrocyclones 93.1, 93.2, 93.3.

In a preferred embodiment, the liquid phase separation system 110 comprises a pump NU13 with associated motor M7 to remove sediment SE from the gravity dynamic separator 114, as illustrated in FIG. 9.

In a preferred embodiment, the sediment SE is fed into a settling hopper 121 (see FIG. 10).

In a preferred embodiment, at the gravity dynamic separator's 114 outlet 113, the following parameters of the water flow are achieved: a liquid hydrocarbon content of the plant water PW of less than 0.5%; solid inclusions SI content in the plant water PW of less than 0.5%. In the liquid hydrocarbon (liquid MHC) flow in the pipe, hose or connection 117 the water content is less than 1%. The solids content is less than 0.5%.

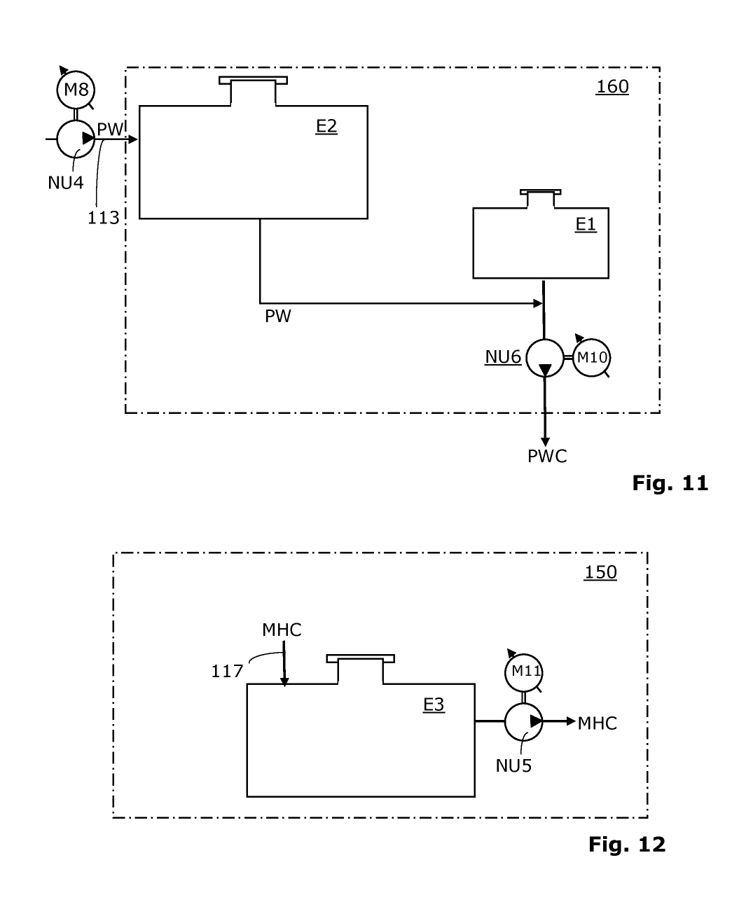

In a preferred embodiment, the liquid phase separation system 110 comprises a pump NU4 with associated motor M8 for purified water handling. The plant water PW purified from liquid hydrocarbons is returned to the cycle by the pump NU4 which transfers the plant water PW to the system 160 to prepare process water composition PWC. The system 160 might comprise a tank 20 (corresponds to tank E1 in FIG. 11) Preferably, the plant water PW is transferred into one or more hydrocyclones (not shown) of the system 160 to prepare process water composition PWC. These optional hydrocyclones (not shown) provide for an additional purification from solids. If no hydrocyclone/s is/are employed, the purified plant water PW, as provided by the gravity dynamic separator 114, can be fed right into a tank E2, as illustrated in FIG. 11.

In all embodiments of the invention the process water composition PWC might be heated either by a heat exchanger (not shown) or by a heating system (not shown).

In all embodiments of the invention a shortage of plant water PW in the tank E2 might be replenished either from a water supply system or from a tanker. Water can also be taken from the ocean (a desalination is required in this case).

### Solid Phase Discharge System 120:

It is the purpose of the solid phase discharge system 120 to handle and discharge cake. The solid phase discharge system 120 preferably comprises a cake intake and settling hopper 121 with an inlet or intake 122, as illustrated in FIG. 10. The cake intake and settling hopper 121 receives pulp P1, P2, P3, P4, cake or solid inclusions SI or sediments SE for one or more of the other stages or systems.

The solid phase discharge system 120 preferably further comprises a cake extraction lifting bail 123 and a measuring hopper 124 having the capacity to load cake into a vehicle 125 (e.g. a road transport vehicle). The solid phase discharge system 120 might comprise a pump NU3 to transfer clarified water PW1 from the settling hopper 121 into the liquid phase separation unit 110, as illustrated in FIG. 9 by means of a dashed line 115. The dashed line 115 schematically represents a pipe, hose or inlet. The lifting bail 123 is designed to extract (watery) cake (solid inclusions SI or sediments SE) from the settling hopper 121. In a preferred embodiment the cake (solid inclusions SI or sediments SE) have an oil content of up to 5% and a water content of up to 30%.

### System 130 for Circulation of Process Water Composition PWC:

It is the main purpose of the system 130 (not shown) for circulation of process water composition PWC to support the process water composition PWC circulation and, if desired the heating and circulation of heat medium (e.g. hot water).

The respective system 130 provides intake of the liquid emulsifier NHS or liquid emulsifier concentrate NHSc. Preferably, it employs a dosing pump NU7 (see FIG. 9) with associated motor M9 for feeding the liquid emulsifier NHS or liquid emulsifier concentrate NHSc into the liquid phase separation system 110, as indicated in FIG. 9. The liquid emulsifier NHS or liquid emulsifier concentrate NHSc is either pumped into a pipe or hose at the inlet 111 of the liquid phase separation system 110, or the liquid emulsifier NHS or liquid emulsifier concentrate NHSc is pumped right into the gravity dynamic separator 114 of the liquid phase separation system 110. The dosing pump NU7 is controlled (preferably by the automatic control system ACS) so as to ensure that a pre-defined maxing ratio of liquid emulsifier NHS or liquid emulsifier concentrate NHSc and pulp P1, P2, P3, P4 or purified liquid phase pLF is obtained. The automatic control system ACS controls the associated motor M9 of the pump NU7, as schematically illustrated by a dashed arrow 116.

All other pumps are also is controllable by the automatic control system ACS. The respective control connections are not shown.

In a preferred embodiment another dosing pump NU6 with associated motor M10 is employed in order to supply the process water composition PWC supply to the tumbler 60 (see FIG. 4) and/or the stirrer 70 (see FIG. 5) and/or the hydrojet treatment system 80 (see FIG. 6) of the large-scale purification system.

In a preferred embodiment the system 130 for circulation of process water composition PWC comprises one or more of the following additional elements: a recirculation pump; a pump to exhaust extracted water; process and excess water consumption meters; a heat exchanger; a heating system for (pre-) heating the process water composition PWC; a closed-loop PWC supply line.

### System 160 to Prepare Process Water Composition PWC:

It is the main purpose of the system 160 to prepare process water composition PWC to prepare the process water composition PWC on the basis of plant water PW and the liquid emulsifier NHS or the liquid emulsifier concentrate NHSc. This system 160 preferably also provides for a purification of plant water PW extracted from the liquid phase separation system 110 to be used in the technological process of the present invention.

In a preferred embodiment the system 160 to prepare process water composition PWC comprises one or more of the following (additional) elements: a tank E1 for the storage of the liquid emulsifier NHS or the liquid emulsifier concentrate NHSc, as schematically illustrated in FIG. 11; a tank E2 for the storage of plant water PW, as schematically illustrated in FIG. 11; a tank (not shown) for the storage of excess (extracted) water; one or two hydrocyclones (already mentioned but not shown) for a final purification of the plant water PW.

### Hydrocarbons Storage System 150:

The main purpose of the hydrocarbons storage system 150 is the intake and dispensing of liquid hydrocarbons MHC extracted in the oil sludge treatment process of the invention. This system 150 includes one or more of the following (additional) elements: a liquid hydrocarbons metering subunit (not shown); a tank E3 for collection and storage of liquid hydrocarbons MHC received from the liquid phase separation system 110 (the tank E3 preferably comprises a pipe, hose or connection 117 for feeding the liquid hydrocarbons MHC from the gravity dynamic separator 114 to the tank E3); a pump NU5 with associated motor M11 in order to be able to take liquid hydrocarbons (oil products OP) out of the tank E3.

In order to reduce the probability of forming stable emulsions due to turbulence of technological streams inside systems and or hoses or pipes of the apparatus 1000, the apparatus 1000 preferably includes screw pumping units. The respective screw pumping units can be driven by an associated motor (cf. screw pumping unit NU11 in FIG. 1 which is driven by the first motor M1, for instance) or it can be driven by a compressor 11 (cf. screw pumping unit NU11 in FIG. 2 which is driven by the compressor 11, for instance).

During the treatment of oil sludge, an automated system for preparation and dispensing of a high performance liquid emulsifier NHS or liquid emulsifier concentrate NHSc is used in the apparatus 1000 to obtain the maximum result from separation of sludge into the components—cake, mixture of hydrocarbons and water.

The technology of the present invention enables the processing of oil sludge with hydrocarbons content in liquid phase without limitation and with solid phase content of up to 80%. The oil sludge treatment of the present invention is performed at an ambient temperature not less than plus 5° C.

The oil sludge treatment technological process of the invention is fully or partially automated and requires minimum assistance of operators in the operating process. Testing and control over the treatment process might be performed from an operator's room and or the ACS.

To test the quality of extracted products obtained after oil sludge division and the concentration of reagents (NHS and/or NHSc) used in the apparatus 1000, samples might be taken for further study in an express laboratory. Such a laboratory might be included in the apparatus 1000. The optional operator's room is at least equipped with a control computer (operator workstation).

All electrical equipment mounted in the apparatus 1000 might contain necessary start and stop devices and alarm systems in accordance with the electrical safety requirements.

The equipment and units operating under excessive pressure, are provided with all necessary protection and regulation elements. Indications of the main parameters of the complex operation and alarm signals might be displayed on a monitor of the operator workstation.

An optional automatic control system (ACS) and optional additional bypassing elements provide enhanced abilities to control flows in all stages/systems of the apparatus 1000.

In all embodiments of the invention the apparatus 1000 might comprise bypass lines, meters, flow control devices, shutoff and control valves, and additional pumps. These elements (not shown) are well known to a person skilled in the art and can be employed as required.

| | |
|---|---|
| liquid feedstock mixture | 1 |
| Watery feedstock mixture | 2 |
| oil sludge storage facility (OSSF) | 3 |
| floating roof, float or vessel | 4 |
| intake device | 10 |
| compressor | 11 |
| compressor | 12 |
| agitator | 13 |
| pipe or hose | 14 |
| outlet end or nozzle | 15 |
| dome or container | 16 |
| preliminary separation tank | 50 |
| outlet | 51 |
| Water outlet | 53 |
| pulp feed-line | 54 |
| tumbler | 60 |
| hopper | 61 |
| inlet | 62 |
| nozzle or nozzle array | 63 |
| inlet | 64 |
| nozzle or nozzle array | 65 |
| gravity chute | 66 |
| stirrer | 70 |
| outlet | 71 |
| agitator | 72 |
| hydrojet treatment system | 80 |
| outlet | 81 |
| PWC inlet | 82 |
| nozzle | 83 |
| System to separate pulp into liquid and | 90 |
| solid phases | |
| inlet | 91 |
| outlet | 92 |
| First hydrocyclone | 93.1 |
| second hydrocyclone | 93.2 |
| third hydrocyclone | 93.3 |
| port | 94 |
| inlet | 95 |
| outlet | 96 |
| liquid phase separation system | 110 |
| inlet | 111 |
| Outlet | 112 |
| Outlet | 113 |
| gravity dynamic separator | 114 |
| pipe, hose or inlet | 115 |
| Control connection | 116 |
| pipe, hose or connection | 117 |
| solid phase discharge system | 120 |
| cake intake and settling hopper | 121 |
| inlet or intake | 122 |
| cake extraction lifting bail | 123 |
| measuring hopper | 124 |
| vehicle | 125 |
| system for circulation of process water | 130 |
| composition | |
| system for storing hydrocarbons | 140 |
| hydrocarbons storage system | 150 |
| System to prepare process water | 160 |
| composition | |
| separating system | 200 |
| Apparatus/Plant | 1000 |
| automatic control system | ACS |
| tank | E1/20 |
| tank | E2 |
| tank | E3 |
| tank | E4 |
| Liquid phase | LF |
| motor | M1 |
| motor | M2 |
| motor | M3 |
| motor | M4 |
| motor | M5 |
| motor | M6 |
| motor | M7 |
| motor | M8 |
| motor | M9 |
| motor | M10 |
| motor | M11 |
| motor | M12 |
| hydrocarbons | MHC |
| liquid emulsifier | NHS |
| liquid emulsifier concentrate | NHSc |
| pump | NU1 |
| fifth pump | NU4 |
| sixth pump | NU5 |
| dosing pump | NU6 |
| dosing pump | NU7 |
| First pump | NU10 |
| Second pump/boost pump | NU11 |
| third pump | NU13 |
| fourth pump | NU50 |
| sludge pump | NUSh2 |
| Oil products | OP |
| oil sludge storage facility | OSSF |
| first pulp | P1 |
| second pulp | P2 |
| diluted pulp | P3 |
| Mixed pulp | P4 |
| purified liquid phase | pLF |
| Plant water | PW |
| clarified water | PW1 |
| process water composition/working | PWC |
| solution | |
| solid division products | SD |
| sediment | SE |
| solid phase | SF |
| solid inclusions | SI |
| washing-out water | WoW |

1. Apparatus (1000) for the extraction of liquid hydrocarbons (MHC), comprising
means (130, 160) for providing a process water composition (PWC) comprising a liquid emulsifier (NHS) and water (PW),
an intake device (10) for collecting a liquid feedstock mixture (1) comprising said hydrocarbons (MHC),
a separating system (200) connectable to said intake device (10), said separating system (200) providing for a processing of said liquid feedstock mixture (1) together with said process water composition (PWC) so as to extract at least some of the hydrocarbons (MHC) from said liquid feedstock mixture (1),
wherein said liquid emulsifier (NHS) comprises
(a.) a natural plant oil,
(b.) an emulsifier, and
(c.) preferably also a solubilizer.

2. Apparatus (1000) according to claim 1, wherein said liquid emulsifier (NHS) is provided by said apparatus (1000)
by diluting a liquid emulsifier concentrate (NHSc) with water (PW), said liquid emulsifier (NHS) preferably having a dilution ratio of 1 part of said liquid emulsifier concentrate (NHSc) and 70 to 130 parts water, or
by diluting said liquid emulsifier (NHS) with water, said process water composition (PWC) preferably having a water and liquid emulsifier (NHS) composition in the ratio of 10:1 to 500:1.

3. Apparatus (1000) according to claim 1, wherein said intake device (10) comprises
an agitator (13) enabling an improved collection of said liquid feedstock mixture (1), and/or
a pipe or hose (14) for releasing washing-out water (WoW) enabling an improved collection of a watery feedstock mixture (2) which comprises said liquid feedstock mixture (1) and in some cases also solid inclusions (SI).

4. Apparatus (1000) according to claim 1, wherein said intake device (10) is part of a tank or container containing said liquid feedstock mixture (1), or wherein said intake device (10) is designed for being inserted into a tank or container containing said liquid feedstock mixture (1).

5. Apparatus (1000) according to claim 1, wherein said separating system (200) comprises a separation tank (50) being connectable to said intake device (10), said separation tank (50) being designed to provide for an extraction of first pulp (P1) from said liquid feedstock mixture (1) or from a watery feedstock mixture (2), said separation tank (50) having an outlet (51) for providing said first pulp (P1).

6. Apparatus (1000) according to claim 1, wherein said separating system (200) comprises a tumbler (60) either being connectable to a separation tank (50) so as to receive a first pulp (P1) from said separation tank (50), or being connectable to said intake device (10) so as to receive said liquid feedstock mixture (1) or a watery feedstock mixture (2), said tumbler (60) being designed to provide for a separation of solid inclusions (SI) from said first pulp (P1), or from said liquid feedstock mixture (1) or from said watery feedstock mixture (2) in order to release a second pulp (P2) purified from said solid inclusions (SI) and wherein said tumbler (60) preferably is a tumbler screening machine.

7. Apparatus (1000) according to claim 6, wherein said tumbler (60) enables the mixing of said first pulp (P1), or said liquid feedstock mixture (1) or said watery feedstock mixture (2) with said process water composition (PWC).

8. Apparatus (1000) according to claim 6, further comprising a hopper (61) being arranged so that said tumbler (60) is able to discharge said solid inclusions (SI) into said hopper (61).

9. Apparatus (1000) according to claim 1, wherein said separating system (200) comprises a stirrer (70), preferably a hot-plate stirrer, either providing for a dilution of said liquid feedstock mixture (1) or of a watery feedstock mixture (2), or providing for a dilution of pulp (P1, P2), said stirrer (70) having an outlet (71) for releasing a diluted pulp (P3).

10. Apparatus (1000) according to claim 1, wherein said separating system (200) either comprises a hydrojet treatment system (80) being connectable to said intake device (10) for processing said liquid feedstock mixture (1) or a watery feedstock mixture (2), or a hydrojet treatment system (80) being feedable by pulp (P1, P2, P3) provided by a down-stream system (50, 60, 70), said hydrojet treatment system (80) providing for a mixing of components or elements of said liquid feedstock mixture (1), or watery feedstock mixture (2), or pulp (P1, P2, P3), and said hydrojet treatment system (80) having an outlet (81) for releasing mixed pulp (P4).

11. Apparatus (1000) according to claim 1, wherein said separating system (200) comprises a system (90) which is designed to separate pulp (P1, P2, P3, P4) into liquid and solid phases in the form of purified pulp (pLF) and solid division products (SD).

12. Apparatus (1000) according to claim 11, wherein said system (90) comprises at least one hydrocyclone (93.1) being designed in order to separate solid inclusions (SI) or solid division products (SD) from said pulp (P1, P2, P3, P4) received via an inlet (91), said hydrocyclone/s (93.1) having an outlet (92) for releasing said purified pulp (pLF).

13. Apparatus (1000) according to claim 12, wherein said at least one hydrocyclone (93.1) has a port (94) for releasing said solid inclusions (SI) or solid division products (SD).

14. Apparatus (1000) according to claim 1, further comprising a liquid phase separation system (110), said liquid phase separation system (110) having an inlet (111) for receiving pulp (P1, P2, P3, P4, pLF) from a down-stream system (50, 60, 70, 80, 90) and being designed in order to provide for a separation of water (PW) and liquid hydrocarbons (MHC) from said pulp (P1, P2, P3, P4, pLF) received via said inlet (111).

15. Apparatus (1000) according to claim 14, wherein said liquid phase separation system (110) comprises a gravity dynamic separator (114) with an outlet (117) providing liquid hydrocarbons (MHC), an outlet (112) providing sediments (SE), and an outlet (113) providing said water (PW).

16. Apparatus (1000) according to claim 14 further comprising a solid phase discharge system (120).

17. Apparatus (1000) according to claim 1, wherein said apparatus (1000) comprises a system for circulation of process water composition (130) which is either part of said means (130, 160) for providing a process water composition (PWC) or which is connectable to said means (130, 160) for providing a process water composition (PWC).

18. Apparatus (1000) according to claim 1, wherein said apparatus (1000) comprises a system for storing hydrocarbons (140).

19. Use of an apparatus according to claim 1 for the extraction of liquid hydrocarbons (MHC) from water, soil, sand, rocks or from other objects or materials.

20. Method for extracting liquid hydrocarbons (MHC) from a liquid feedstock mixture (1) comprising said hydrocarbons (MHC), comprising the steps:
Providing a liquid emulsifier (NHS),
providing a process water composition (PWC) comprising an amount of said liquid emulsifier (NHS) and water (PW),
collecting said liquid feedstock mixture (1) using an intake device (10),
processing said liquid feedstock mixture (1) together with said process water composition (PWC) so as to extract at least some of the hydrocarbons (MHC) from said liquid feedstock mixture (1),
wherein said liquid emulsifier (NHS) comprises
(a.) a natural plant oil,
(b.) an emulsifier, and
(c.) preferably also a solubilizer.

21. Method according to claim 20, comprising the step:
filling said liquid feedstock mixture (1) into a tank or container from where said liquid feedstock mixture (1) can be collected by said intake device (10).

22. Method according to claim 20, comprising the step:
taking or gathering said liquid feedstock mixture (1) from a lake, pond or from an ocean area by means of said intake device (10).
